(19) United States
(12) Patent Application Publication
(10) Pub. No.: US 2015/0179340 A1
(43) Pub. Date: Jun. 25, 2015

(54) MULTILAYER CERAMIC CAPACITOR AND METHOD OF FABRICATING THE SAME

(71) Applicant: SAMSUNG ELECTRO-MECHANICS CO., LTD., Suwon-Si (KR)

(72) Inventors: Kang Heon HUR, Suwon (KR); Byung Gyun KIM, Jinhae (KR); Sang Hoon KWON, Suwon (KR); Doo Young KIM, Yongin (KR); Hyun Tae KIM, Seoul (KR); Mi Young KIM, Suwon (KR); Eun Sang NA, Yongin (KR); Jae Joon LEE, Seoul (KR)

(21) Appl. No.: 14/642,229

(22) Filed: Mar. 9, 2015

Related U.S. Application Data
(63) Continuation of application No. 12/976,500, filed on Dec. 22, 2010.

(30) Foreign Application Priority Data
Dec. 22, 2009 (KR) 10-2009-0129304

(51) Int. Cl. H01G 4/008; H01G 4/30; H01G 4/12; H01G 4/012

(52) U.S. Cl. CPC H01G 4/008; H01G 4/012; H01G 4/30; H01G 4/12

(57) ABSTRACT

There is provided a multilayer ceramic capacitor including: a capacitor main body formed by alternately stacking an internal electrode including an internal electrode-forming material and a dielectric layer; and an external electrode formed on the external surface of the capacitor to be electrically connected to the internal electrode and having an external electrode-forming material, wherein the internal electrode includes a non-diffusion layer including the external electrode-forming material of 2 vol % to 20 vol % and a diffusion layer made of the external electrode-forming material on at least one of the both ends of the non-diffusion layer. The multilayer ceramic capacitor capable of preventing cracking due to the diffusion of electrode materials while stably securing capacitance and the method of fabricating the same can be provided.

### CROSS-REFERENCE TO RELATED APPLICATIONS

This application is a continuation of U.S. patent application Ser. No. 12/976,500, filed Dec. 22, 2010, which claims the priority of Korean Patent Application No. 10-2009-0129304 filed on Dec. 22, 2009, the disclosures of which are incorporated herein by reference.

### BACKGROUND OF THE INVENTION

1. Field of the Invention

The present invention relates to a multilayer ceramic capacitor and a method of fabricating the same, and more particularly, to a multilayer ceramic capacitor capable of preventing cracking due to the diffusion of an electrode material while stably securing capacitance and a method of fabricating the same.

2. Description of the Related Art

In general, a multilayer ceramic capacitor (MLCC) includes a plurality of ceramic dielectric sheets and internal electrodes inserted between the plurality of ceramic dielectric sheets. The multilayer ceramic capacitor can implement high capacitance with a compact size and can be easily mounted on a substrate, such that it has been widely used as a capacitive component for various electronic devices.

Recently, with the development of the compact and multi-functional electronic products, chip components are becoming smaller with higher performances. As a result, there has been increased a demand for a compact and highly capacitive multilayer ceramic capacitor. Therefore, a multilayer ceramic capacitor having a dielectric layer thickness of 2 μm or less and stacked layers of 500 or more has been recently fabricated.

An external electrode is installed on a side cross-section of the side cross-sections of such a ceramic capacitor, on which an internal electrode is exposed, wherein according the prior art, in general, a conductive paste used for forming the external electrode contains a general copper powder, the powder being mixed with a glass frit, a base resin, an organic vehicle and the like.

The external electrode paste is applied on the side cross-section of the ceramic capacitor and the ceramic capacitor applied with the external electrode paste is fired to sinter a metallic powder in the external electrode paste, thereby forming the external electrode.

In the case of a low-stacked ceramic capacitor, although a diffusion layer is sufficiently formed between the external electrode and the internal electrode, cracking due to diffusion from the external electrode to the internal electrode does not occur. Therefore, the main concern in constructing an MLCC has been to reduce deviations in capacitance by maximally improving contact between the external electrode and the internal electrode using one of a grinding technology, an external electrode paste composition, and a main technology of firing the external electrode.

However, in the case of an ultra-high capacitive, high-stacked ceramic capacitor, it has a serious problem not occurred in a low-stacked ceramic capacitor, even though contact between the external electrode and the internal electrode is improved. More specifically, when the diffusion from the external electrode to the internal electrode of the high-stacked ceramic capacitor is severely generated, cracking occurs due to a volume expansion of the internal electrode, flexural strength is lowered due to the generated cracking, and a plating solution is infiltrated through the cracking, thereby degrading the reliability of products.

### SUMMARY OF THE INVENTION

An aspect of the present invention provides a multilayer ceramic capacitor capable of preventing cracking due to the diffusion of an electrode material while stably securing capacitance and a method of fabricating the same.

According to an aspect of the present invention, there is provided a multilayer ceramic capacitor including: a capacitor main body formed by alternately stacking an internal electrode including an internal electrode-forming material and a dielectric layer; and an external electrode formed on the external surface of the capacitor to be electrically connected to the internal electrode and having an external electrode-forming material, wherein the internal electrode includes a non-diffusion layer including the external electrode-forming material of 2 vol % to 20 vol % and a diffusion layer made of the external electrode-forming material on at least one of the both ends of the non-diffusion layer.

Herein, the non-diffusion layer may include nickel (Ni) or a nickel alloy (Ni-alloy) and the external electrode-forming material.

Meanwhile, the external electrode-forming material may include copper (Cu) or a copper alloy (Cu alloy).

Further, the diffusion layer may include a nickel and copper alloy (Ni/Cu alloy).

Herein, the number of stacked dielectric layers may be 50 to 1000.

According to another aspect of the present invention, there is provided a method of fabricating a multilayer ceramic capacitor, including: forming a capacitor main body by alternately stacking an internal electrode including an internal electrode-forming material and a dielectric layer; forming a protective layer including a dielectric-forming material on at least one surface of the upper surface and the lower surface of the capacitor main body; pressurizing the capacitor main body; and firing the capacitor main body, wherein the internal electrode includes a non-diffusion layer including the external electrode-forming material of 2 vol % to 20 vol % and a diffusion layer made of the external electrode-forming material on at least one of the both ends of the non-diffusion layer.

Herein, the non-diffusion layer may include nickel (Ni) or a nickel alloy (Ni-alloy) and the external electrode-forming material.

Meanwhile, the external electrode-forming material may include copper (Cu) or a copper alloy (Cu alloy).

Further, the diffusion layer may include a nickel and copper alloy (Ni/Cu alloy).

Herein, the method may further include cutting the capacitor main body between the pressurizing and the firing, in order to form a separate unit.

Herein, the number of stacked dielectric layers may be 50 to 1000.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view showing a multilayer ceramic capacitor according to an exemplary embodiment of the present invention;

FIG. 2 is a cross-sectional view taken along line A-A′ of FIG. 1;

FIG. 3 is a cross-sectional view taken along line B-B′ of FIG. 1; and

FIGS. 4A through 4C are cross-sectional views schematically showing main fabricating processes of a multilayer ceramic capacitor according to an exemplary embodiment of the present invention.

### DETAILED DESCRIPTION OF THE PREFERRED EMBODIMENT

Hereinafter, exemplary embodiments will be described in detail with reference to the accompanying drawings so that they can be easily practiced by those skilled in the art to which the present invention pertains. However, in describing the exemplary embodiments of the present invention, detailed descriptions of well-known functions or constructions are omitted so as not to obscure the description of the present invention with unnecessary detail.

In addition, like reference numerals denote parts performing similar functions and actions throughout the drawings.

It will be understood that when an element is referred to as being “connected with” another element, it can be directly connected with the other element or may be indirectly connected with the other element with element (s) interposed therebetween. Unless explicitly described to the contrary, the word “comprise” and variations such as “comprises” or “comprising,” will be understood to imply the inclusion of stated elements but not the exclusion of any other elements.

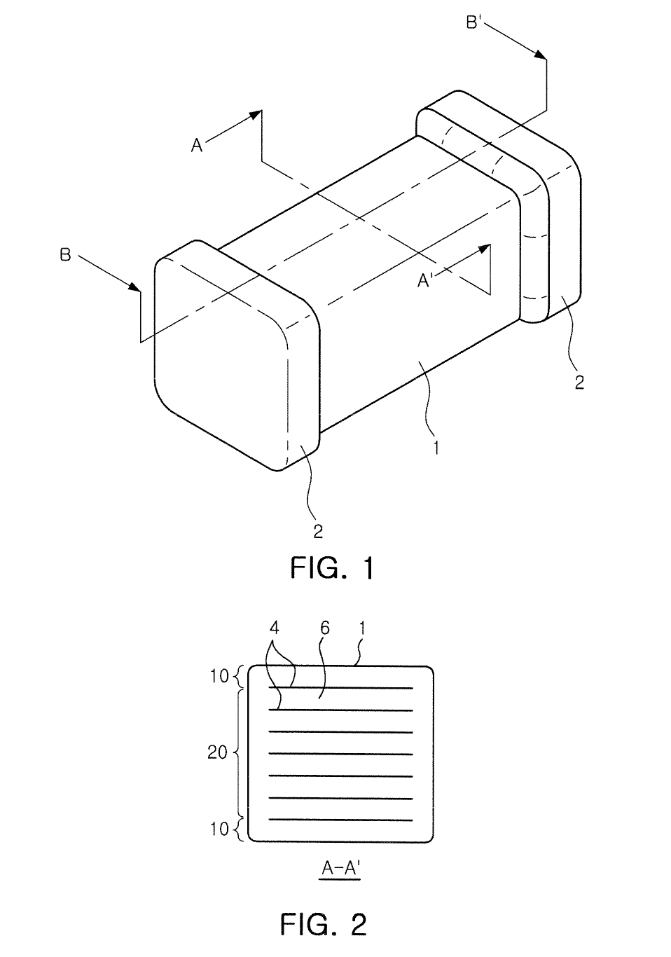

Hereinafter, a multilayer ceramic capacitor and main fabricating processes according to exemplary embodiments of the present invention will be described with reference to FIGS. 1 through 4C.

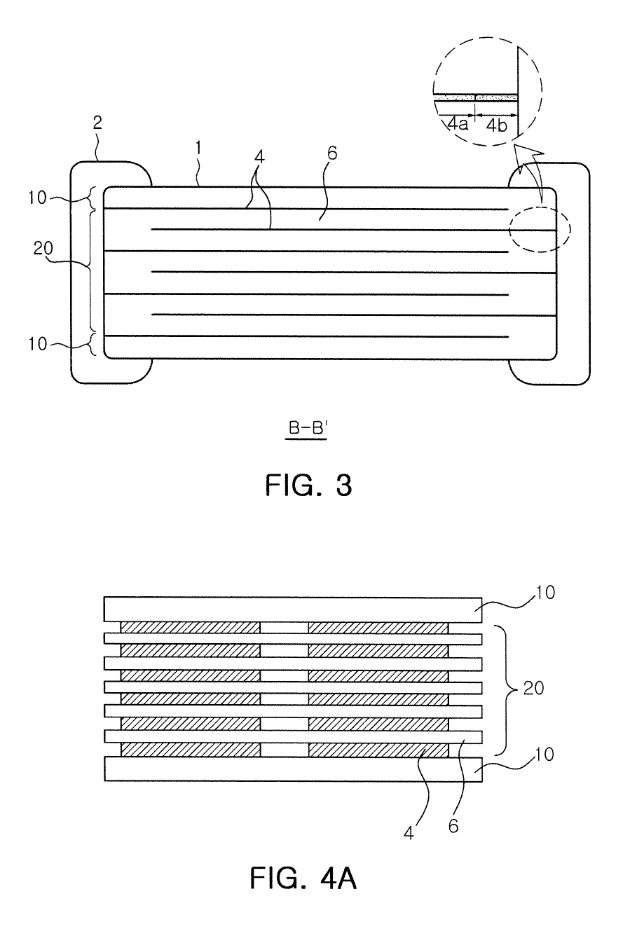

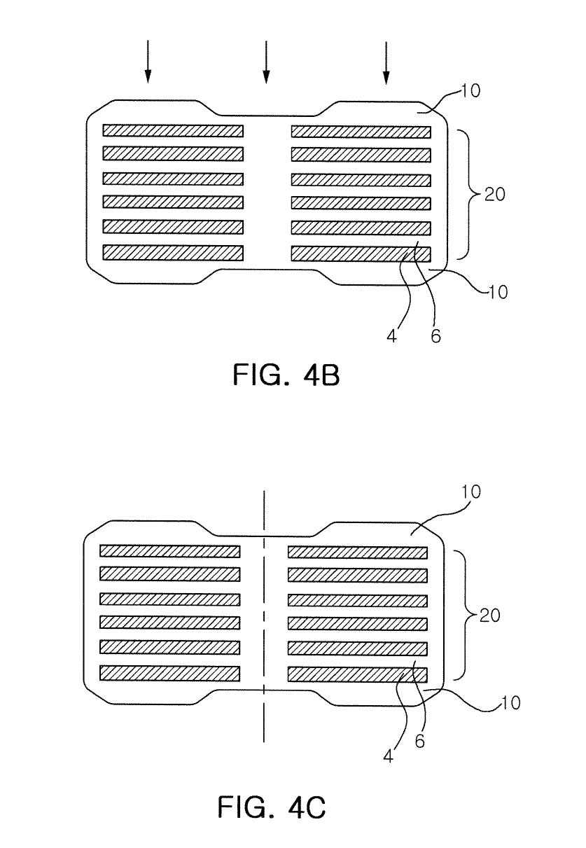

FIG. 1 is a perspective view schematically showing a multilayer ceramic capacitor according to an exemplary embodiment of the present invention, FIG. 2 is a cross-sectional view taken along line A-A′ of FIG. 1, FIG. 3 is a cross-sectional view taken along line B-B′ of FIG. 1, and FIGS. 4A through 4C are cross-sectional views schematically showing main fabricating processes of a multilayer ceramic capacitor according to an exemplary embodiment of the present invention.

A multilayer ceramic capacitor according to an embodiment of the present invention may include a capacitor main body 1 and an external electrode 2.

The capacitor main body 1 includes a plurality of dielectric layers 6 stacked therein and an internal electrode 4 that may be inserted between the plurality of dielectric layers 6. At this time, the dielectric layer 6 may be made of barium titanate (Ba₂TiO₃) and the internal electrode 4 may be made of nickel (Ni) or a nickel alloy (Ni alloy) and an external electrode-forming material, wherein the internal electrode 4 may include a non-diffusion layer 4a including the external electrode-forming material of 2 vol % to 20 vol % and a diffusion layer 4b made of the external electrode-forming material on at least one of both ends of the internal electrode 4.

The external electrode 2 may be formed at both end surfaces of the capacitor main body 1. The external electrode 2 is formed to be electrically connected to the internal electrodes 4 that are exposed to the outer surface of the capacitor main body 1, thereby making it possible to perform a role of an external terminal. At this time, the external electrode 2 may be made of copper (Cu) and a copper alloy (Cu alloy). Therefore, the diffusion layer 4b contacting the external electrode 2 includes the external electrode 2-forming material diffused from the external electrode 2, thereby making it possible to include nickel (Ni) and the copper alloy (Cu alloy).

The multilayer ceramic capacitor according to an embodiment of the present invention may include an effective layer 20 in which the dielectric layer 6 and the internal electrode 4 are alternately stacked. In addition, the multilayer ceramic capacitor may include a protective layer 10 formed by stacking dielectric layers on the upper and lower surfaces of the effective layer 20.

The protective layer 10 is formed by continuously stacking a plurality of dielectric layers on the upper and lower surfaces of the effective layer 20, thereby making it possible to protect the effective layer 20 from external impacts and the like.

When the internal electrode 4 of the effective layer 20 is made of nickel (Ni), the thermal expansion coefficient thereof is about 13×10−6/° C. and the thermal expansion coefficient of the dielectric layer 6 made of ceramic is about 8×10−6/° C. When thermal impacts are applied to the circuit board by firing, reflow solder and the like, during amounting process, due to the difference in the thermal expansion coefficients between the dielectric layer 6 and the internal electrode 4, stress is applied to the dielectric layer 6. Therefore, cracking may occur in the dielectric layer 6 due to stress when the thermal impact is applied. Also, when there is a severe diffusion from the external electrode 2 to the internal electrode 4, cracking may also occur in the dielectric layer 6 due to the expansion of the volume of the internal electrode 4. Owing to the infiltration of a plating solution through the cracking generated above, the reliability of products may be degraded.

Therefore, in view of securing stable capacitance and preventing cracking generated due to thermal impacts and the expansion of the volume of the internal electrode 4, the internal electrode 4 includes the non-diffusion layer 4a including the external electrode-forming material of 2 vol % to 20 vol %, in addition to the internal electrode 4-forming material made of nickel (Ni) or the nickel alloy (Ni alloy), and the diffusion layer 4b made of the external electrode 2-forming material on at least one of both ends of the internal electrode 4 after firing the non-diffusion layer 4a, thereby making it possible to improve contact with the external electrode 2. The amount of the external electrode-forming material added to the internal electrode 4-forming material may be determined by experimentation.

### Embodiment

As shown in FIG. 4A, the dielectric layer 6 of the capacitor main body 1 was formed to include a binder, a plasticizer, and a residual dielectric material. A conductive internal electrode 4 was printed on the dielectric layer 6 obtained by molding a slurry including the construction material. The internal electrode-forming material was made by adding copper (Cu), the external electrode-forming material, to nickel (Ni), and the content of copper was variously changed so that it was in the range of 0 vol % to 30 vol %. Next, a laminate having a predetermined thickness was fabricated using the printed dielectric layer 6. Herein, the dielectric layer 6 was formed to have 50 to 1000 stacked layers.

Then, as shown in FIG. 4B, the dielectric layer 6 was pressurized at a predetermined temperature. Herein, the W cross-section of the multilayer ceramic capacitor where the empty space between the internal electrodes 4 printed in parallel and the dielectric layer 6 are alternately stacked to have a large accumulated step is provided by way of example. In the L cross-section of the multilayer ceramic capacitor, although the dielectric layer 6 was stacked on the empty space between the internal electrodes 4 printed in parallel as shown in the W cross-section, the empty space between the internal electrodes 4, again printed in parallel, was not positioned on the dielectric layer 6, but the internal electrodes 4 were printed thereon, apart from the W cross-section. Therefore, the W cross-section has a relatively larger accumulated step than the L cross-section; the dielectric layer 6 was deeply collapsed between the internal electrodes 4 printed in parallel at the time of pressurization.

Then, as shown in FIG. 4C, the collapsed portion of the multilayer ceramic capacitor was cut, thereby forming a separate multilayer ceramic capacitor.

Then, the external electrode 2 including copper was attached and firing and plating processes were performed, thereby completing the multilayer ceramic capacitor as shown in FIG. 1.

TABLE 1

| | | | | | Number of | |
|---|---|---|---|---|---|---|
| | Depth of | Number of | | | generated | |
| Em- | diffusion | generated | Capac- | Capac- | cracks | Reliability |
| bodi- | layer | diffusion | itance | itance | (Defect/ | (Defect/ |
| ment | (μm) | layers | ((μF)) | (Cpk) | Sample) | Sample) |
| 1 | 0 | 0 | 0.08 | −5.81 | 0/30 | 0/40 |
| 2 | 0.5 | 1-5 | 0.26 | −3.98 | 0/30 | 0/40 |
| 3 | 0.5 | 6-10 | 0.88 | 0.82 | 0/30 | 0/40 |
| 4 | 1 | 1-5 | 1.08 | 2.81 | 0/30 | 0/40 |
| 5 | 1 | 6-10 | 1.05 | 2.92 | 0/30 | 0/40 |
| 6 | 2 | 1-5 | 1.09 | 2.95 | 0/30 | 0/40 |
| 7 | 2 | 6-10 | 1.11 | 2.95 | 0/30 | 0/40 |
| 8 | 3 | 1-5 | 1.09 | 2.53 | 0/30 | 0/40 |
| 9 | 3 | 6-10 | 1.12 | 2.71 | 0/30 | 0/40 |
| 10 | 7 | 1-5 | 1.10 | 2.78 | 0/30 | 0/40 |
| 11 | 7 | 6-10 | 1.09 | 2.81 | 0/30 | 0/40 |
| 12 | 10 | 1-5 | 1.13 | 2.83 | 0/30 | 0/40 |
| 13 | 10 | 6-10 | 1.11 | 2.99 | 0/30 | 0/40 |
| 14 | 13 | 1-5 | 1.09 | 2.76 | 0/30 | 0/40 |
| 15 | 13 | 6-10 | 1.12 | 2.92 | 0/30 | 0/40 |
| 16 | 16 | 1-5 | 1.11 | 2.75 | 0/30 | 0/40 |
| 17 | 16 | 6-10 | 1.14 | 2.82 | 0/30 | 0/40 |
| 18 | 20 | 1-5 | 1.09 | 2.77 | 1/30 | 0/40 |
| 19 | 20 | 6-10 | 1.11 | 2.98 | 3/30 | 1/40 |

TABLE 2

| | Copper content | | | Number of | |
|---|---|---|---|---|---|
| | added to | | | generated | |
| Em- | internal | Capac- | Capac- | cracks | Reliability |
| bodi- | electrode | itance | itance | (Defect/ | (Defect/ |
| ment | (vol %) | (μF) | (Cpk) | Sample) | Sample) |
| 20 | 0 | 1.09 | 2.74 | 2/30 | 2/40 |
| 21 | 1 | 1.08 | 2.65 | 1/30 | 1/40 |
| 22 | 2 | 1.09 | 2.87 | 1/30 | 0/40 |
| 23 | 3 | 1.07 | 2.86 | 0/30 | 0/40 |
| 24 | 5 | 1.09 | 2.97 | 0/30 | 0/40 |
| 25 | 10 | 1.09 | 2.92 | 0/30 | 0/40 |
| 26 | 15 | 1.07 | 2.88 | 0/30 | 0/40 |
| 27 | 20 | 1.06 | 2.75 | 0/30 | 0/40 |
| 28 | 25 | 1.01 | 1.03 | 0/30 | 0/40 |
| 29 | 30 | 0.96 | 0.91 | 0/30 | 0/40 |

Table 1 demonstrates that the capacitance of the multilayer ceramic capacitor, along with the number of generated cracks and reliability with respect to thermal impacts and the diffusion per depth of the diffusion layer 4b of the multilayer ceramic capacitor, were measured, the multilayer ceramic capacitor being formed by applying the copper paste, that is, the external electrode-forming material, to the outer side end of the capacitor main body 1 and firing it with different firing conditions, and the multilayer ceramic capacitor including the internal electrodes 4 being formed by adding copper of 5 vol %, that is, the external electrode-forming material of the multilayer ceramic capacitor according to the present invention. At this time, the number of generated diffusion layers 4b is evaluated based on the results of EPMA analysis at a level of magnification in which ten internal electrodes 4 are able to be shown.

Referring to Table 1, it can be appreciated even when the depth of the diffusion layer 4b is below 1 μm, cracking does not occur and no problems occur in reliability, due to diffusion, and when the depth of the diffusion layer 4b is 1 μm, capacitance is not degraded, while cracking does not occur and no problems occur in reliability. It can also be appreciated that cracking does not occur and no problems occur in the reliability up to the case where the depth of the diffusion layer 4b is 16 μm.

Table 2 demonstrates that the capacitance of the multilayer ceramic capacitor, along with the number of generated cracks and reliability with respect to thermal impacts and diffusion were measured, the multilayer ceramic capacitor being formed by applying the copper paste, that is, the external electrode-forming material, to the outer end of the capacitor main body 1 and firing it at a temperature of 785° C. for 40 minutes, and the multilayer ceramic capacitor including the internal electrodes 4 being formed by varying the content of copper (vol %), that is, the external electrode-forming material added to the internal electrodes 4.

Referring to Table 2, it can be appreciated when the content of copper (vol %), that is the external electrode-forming material added to the internal electrodes 4, is below 2 vol %, there is no improvement in cracking and the reliability due to the diffusion, and when the content of copper (vol %) is above 20 vol %, cracking does not occur and no problems occur in reliability, but a problem occurs in that capacitance is degraded due to the degradation of the connection of the internal electrodes, that is, a disconnection phenomenon.

Therefore, it can be appreciated that when the external electrode-forming material of 2 vol % to 20 vol % is added to the internal electrodes 4, cracking does not occur and no problems occur in reliability up to the case where the depth of the diffusion layer is 16 μm or less.

As set forth above, according to exemplary embodiments of the present invention, the multilayer ceramic capacitor capable of preventing cracking due to the diffusion of electrode materials while stably securing capacitance and the method of fabricating the same can be provided.

In addition, the contact of the interface between the internal electrode and the external electrode is improved, thereby making it possible to prevent cracking due to diffusion from the external electrode to the internal electrode.

In addition, the correlation between the capacitance according to the depth of the diffusion layer from the external electrode to the internal electrode, generated cracking and reliability is proposed, thereby making it possible to improve the reliability of the ultra-high capacitive, high-stacked multilayer ceramic capacitor by controlling the depth of the proper diffusion layer.

While the present invention has been shown and described in connection with the exemplary embodiments, it will be apparent to those skilled in the art that modifications and variations can be made without departing from the spirit and scope of the invention as defined by the appended claims.

What is claimed is:

1. A multilayer ceramic capacitor comprising:
a capacitor main body formed by alternately stacking an internal electrode including an internal electrode-forming material and a dielectric layer; and
an external electrode formed on the external surface of the capacitor to be electrically connected to the internal electrode and having an external electrode-forming material,
wherein the internal electrode includes a non-diffusion layer and a diffusion layer,
wherein the non-diffusion layer includes the external electrode-forming material of 2 vol % to 20 vol %, and
the diffusion layer consists of the external electrode-forming material on at least one end of the both ends of the non-diffusion layer.

2. The multilayer ceramic capacitor of claim 1, wherein the non-diffusion layer includes nickel (Ni) or a nickel alloy (Ni-alloy) and the external electrode-forming material.

3. The multilayer ceramic capacitor of claim 1, wherein the external electrode-forming material includes copper (Cu) or a copper alloy (Cu alloy).

4. The multilayer ceramic capacitor of claim 1, wherein the diffusion layer includes a nickel and copper alloy (Ni/Cu alloy).

5. The multilayer ceramic capacitor of claim 1, wherein the number of stacked dielectric layers is 50 to 1000.

6. The multilayer ceramic capacitor of claim 1, wherein the depth of the diffusion layer is 1 μm to 16 μm.

7. The multilayer ceramic capacitor of claim 1, wherein the diffusion layer is formed on the one end connected to the external electrode of the both ends of the non-diffusion layer.
